(19) United States
(12) Patent Application Publication
(10) Pub. No.: US 2015/0308809 A1
(43) Pub. Date: Oct. 29, 2015

(54) APPARATUS AND METHOD FOR CALCULATING GROUND SURFACE ROUGHNESS

(71) Applicant: Se-Hyu CHOI, Daegu (KR)

(72) Inventor: Se-Hyu CHOI, Daegu (KR)

(21) Appl. No.: 14/124,315

(22) PCT Filed: Nov. 19, 2013
(86) PCT No.: PCT/KR2013/010497

§ 371 Date: Jun. 23, 2015

(30) Foreign Application Priority Data
Nov. 20, 2012 (KR) 10-2012-0131819
Nov. 22, 2012 (KR) 10-2012-0133199
Nov. 22, 2012 (KR) 10-2012-0133201
Feb. 22, 2013 (KR) 10-2013-0019292
Feb. 22, 2013 (KR) 10-2013-0019293
Nov. 18, 2013 (KR) 10-2013-0140106

(51) Int. Cl. G01B 5/28

(52) U.S. Cl. CPC G01B 5/28

(57) ABSTRACT

Provided is an apparatus for calculating ground surface roughness. The apparatus include an information collecting unit collecting height information on a plurality of points in a region; a representative value calculating unit calculating a representative value of the region by using statistical data on the height information; and a ground surface roughness calculating unit calculating the ground surface roughness of the region according to the representative value.

### CROSS-REFERENCE TO RELATED APPLICATIONS

This U.S. non-provisional patent application claims priority under 35 U.S.C. §119 of Korean Patent Application Nos. 10-2012-0131819 filed on Nov. 20, 2012, 10-2012-0133199 filed on Nov. 22, 2012, 10-2012-0133201 filed on Nov. 22, 2012, 10-2013-0019292 filed on Feb. 22, 2013, 10-2013-0019293 filed on Feb. 22, 2013, and 10-2013-0140106 filed on Nov. 18, 2013, the entire contents of which are hereby incorporated by reference.

### BACKGROUND OF THE INVENTION

The present invention disclosed herein relates to an apparatus and method for calculating ground surface roughness.

In designing a structure, wind is one of factors to have to be fundamentally considered. The characteristics of the wind, such as the speed and direction of the wind are strongly affected by surrounding topography, and when the speed of the wind increases by surrounding topography, it may have a strong effect on the safety of a structure. In order to consider load applied to the structure by the wind, wind load is calculated when designing the structure.

The value of the wind load may vary depending on ground surface roughness representing the roughness of the ground surface. However, when designing the structure, the ground surface roughness is often determined by the subjective judgment of a designer, and as a result, there is a limitation in that the safety and economic value of the structure decrease.

### SUMMARY OF THE INVENTION

The present invention provides an apparatus and method for calculating ground surface roughness that objectively and reasonably determines the ground surface roughness of a region considered when calculating wind load.

Embodiments of the present invention provide apparatuses for calculating ground surface roughness include an information collecting unit collecting height information on a plurality of points in a region; a representative value calculating unit calculating a representative value of the region by using statistical data on the height information; and a ground surface roughness calculating unit calculating the ground surface roughness of the region according to the representative value.

In some embodiments, the information collecting unit may be configured to: calculate the height of a building as height information on a point when the point is located on the building; and calculate the height information on the point as 0 when the point is located on the ground or the water surface.

In other embodiments, the points may be uniformly distributed in the region.

In still other embodiments, the points may 1:1 correspond to buildings in the region.

In even other embodiments, the representative value calculating unit may calculate one of the median, maximum value, maximum frequency and mean value of the heights of the points and determine the calculated value as the representative value.

In yet other embodiments, the representative value calculating unit may calculate a frequency distribution for the heights of the points and determine the rank value of a rank having the maximum frequency on the frequency distribution as the representative value.

In further embodiments, the information collecting unit may be include a sample information collecting unit collecting height information on a plurality of sample points in the region; and a target point information obtaining unit obtaining height information on a plurality of target points in the region by using the height information on the sample points.

In still further embodiments, the target point information obtaining unit may be configured to create a digital elevation model (DEM) by using height information collected on the sample points, create a plurality of target points corresponding to the grid of the DEM, and calculate the height of the grid of the DEM as height information on a target information corresponding to the grid.

In even further embodiments, the target point information obtaining unit may be configured to: create a plurality of target points in the region; and calculate height information on the target point by using interpolation based on the height information collected on the sample point.

In yet further embodiments, the information collecting unit may collect information on the height and area of a building in the region, and the representative value calculating unit may apply the area of the building as weight to the height of the building to calculate a weighted average height.

In much further embodiments, the information collecting unit may collect elevation information on a plurality of points in the region and total-height information that the height of a building is reflected to an elevation, the apparatus for calculating the ground surface roughness may further include a ground surface height calculating unit that calculates the ground surface height of the region based on the elevation information, and the representative value calculating unit may calculate the representative value of the region by using statistical data on the difference value of a total height calculated for each point and the ground surface height.

In still much further embodiments, the information collecting unit may be configured to: add the height of a building to the elevation of the ground to calculate the total height of a corresponding point when the point is located on a building; calculate the elevation of the ground or the water surface as the total height of a corresponding point when the point is located on the ground or the water surface.

In even much further embodiments, the ground surface height calculating unit may calculate the minimum value or maximum frequency of the elevations of the points as the ground surface height.

In yet much further embodiments, the ground surface height calculating unit may be configured to: calculate a frequency distribution for the elevations of the points; and calculate, as the ground surface height, the rank value of a rank having the maximum frequency on the frequency distribution, the mean value of an elevations belonging to a rank having the maximum frequency on the frequency distribution, the rank value of a rank having the minimum frequency on the frequency distribution, or the mean value of elevations belonging to a rank having the minimum frequency on the frequency distribution.

In yet much further embodiments, the information collecting unit may further collect location information on a plurality of points in the region, and

the ground surface height calculating unit may use regression analysis to calculate a regression equation based on the location information and the elevation information and apply the location information to the regression equation to calculate a ground surface height for each point.

In yet much further embodiments, the ground surface height calculating unit may set the location information as an independent variable and the elevation information as a dependent variable to calculate the regression equation.

In yet much further embodiments, the ground surface height calculating unit may calculate the regression equation based on location information and elevation information on some of the points.

In yet much further embodiments, the ground surface height calculating unit may be configured to: calculate a frequency distribution for the elevations of the points;

select a point having an elevation belonging to a rank having the maximum or minimum frequency on the frequency distribution; and calculate the regression equation based on location information and elevation information on the selected point.

In other embodiments of the present invention, methods of calculating ground surface roughness in a region by using a ground surface roughness calculating apparatus including an information collecting unit, a representative value calculating unit, and a ground surface roughness calculating unit include collecting, by the information collecting unit, height information on a plurality of points in a region; calculating, by the representative value calculating unit, a representative value of the region by using statistical data on the height information; and calculating, by the ground surface roughness calculating unit, the ground surface roughness of the region according to the representative value.

In still other embodiments of the present invention, computer readable recording mediums on which a program to be executed on a computer is recorded are provided, wherein the program implements a method of calculating ground surface roughness that includes: collecting, by an information collecting unit, height information on a plurality of points in a region; calculating, by a representative value calculating unit, a representative value of the region by using statistical data on the height information; and calculating, by a ground surface roughness calculating unit, the ground surface roughness of the region according to the representative value.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is an exemplary block diagram of an ground surface roughness calculating apparatus according to an embodiment of the present invention;

FIGS. 2 and 3 illustrate a plurality of points in a region considered when calculating wind load and a region from which height information is collected according to an embodiment of the present invention;

FIG. 4 illustrates a process of obtaining height information on a plurality of points in a region according to an embodiment of the present invention;

FIG. 5 is a graph of a plurality of points in a region according to an embodiment of the present invention, the points being represented in height order;

FIG. 6 is an exemplary frequency distribution graph that represents the frequency distribution of the heights of a plurality of points in a region calculated according to an embodiment of the present invention;

FIG. 7 is an exemplary block diagram of an ground surface roughness calculating apparatus according to another embodiment of the present invention;

FIG. 8 is an exemplary plane view of a region considered when calculating wind load and a building included in the region according to another embodiment of the present invention;

FIG. 9 illustrates the central part of a building included in a region according to another embodiment of the present invention;

FIG. 10 illustrates panel points obtained from the outline of a building included in a region according to another embodiment of the present invention;

FIG. 11 illustrates a process of obtaining height information on a plurality of points in a region according to another embodiment of the present invention;

FIG. 12 illustrates a process of calculating weighted average height according to another embodiment of the present invention;

FIG. 13 is an exemplary block diagram of an ground surface roughness calculating apparatus according to another embodiment of the present invention;

FIG. 14 illustrates a process of obtaining elevation information and total-height information on a plurality of points according to another embodiment of the present invention;

FIG. 15 is an exemplary graph of a plurality of points in a region according to another embodiment of the present invention, the points being represented in elevation order;

FIG. 16 is an exemplary frequency distribution graph that represents the frequency distribution of the elevations of a plurality of points in a region according to another embodiment of the present invention;

FIG. 17 illustrates a process of obtaining location information on a plurality of points according to another embodiment of the present invention;

FIG. 18 illustrates a process of producing a regression equation based on location information and elevation information on a point according to another embodiment of the present invention;

FIG. 19 illustrates a process of calculating the ground surface height of each point by using a regression equation according to another embodiment of the present invention; and

FIG. 20 is a flow chart of a ground surface roughness calculating method according to an embodiment of the present invention.

### DETAILED DESCRIPTION OF PREFERRED EMBODIMENTS

Other advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

When some terms are not defined, all the terms used herein (including technology or science terms) have the same meanings as those generally accepted by typical technologies in the related art to which the present invention pertains. The terms defined in general dictionaries may be construed as having the same meanings as those used in the disclosure and/or the related art and even when some terms are not clearly defined, they should not be construed as being conceptual or excessively formal.

The terms used herein are only for explaining specific embodiments while not limiting the present invention. The terms of a singular form may include plural forms unless referred to the contrary. The terms used herein “includes”, “comprises”, “including” and/or “comprising” do not exclude the presence or addition of one or more compositions, ingredients, components, steps, operations and/or elements other than the compositions, ingredients, components, steps, operations and/or elements that are mentioned. In the disclosure, the term “and/or” indicates each of enumerated components or various combinations thereof.

On the other hand, the term “unit”, “group”, “block”, or “module” used herein may mean a unit for processing at least one function or operation. For example, it may mean software or a hardware component such as FPGA or ASIC. However, the term “unit”, “group”, “block” or “module” is not limited to the software or the hardware. The term “unit”, “group”, “block” or “module” may be configured in an addressable storage medium or may be configured to operate one or more processors.

Thus, as an example, the “unit”, “group”, “block” or “module” includes components such as software components, object-oriented software components, class components, and task components, processes, functions, attributes, procedures, sub routines, program code segments, drivers, firmware, micro codes, circuits, data, DBs, data structures, tables, arrays and variables. The components and functions provided in the “unit”, “group”, “block” or “module” may be integrated as a smaller number of components and a smaller number of units, blocks, or modules or may be further divided into further components and further units, groups, or modules. Various embodiments of the present invention are described below in detail with reference to the accompanying drawings.

An apparatus and method for calculating ground surface roughness according to an embodiment of the present invention may collect height information on a plurality of points in a region considered to calculate wind load applied to a building and calculate the ground surface roughness of the region based on a representative value that is obtained by using statistical data on the height information.

The term “structure” used herein covers a building, fittings, an outdoor advertisement, and a bridge and means all articles that are arranged on the space and bear load due to wind.

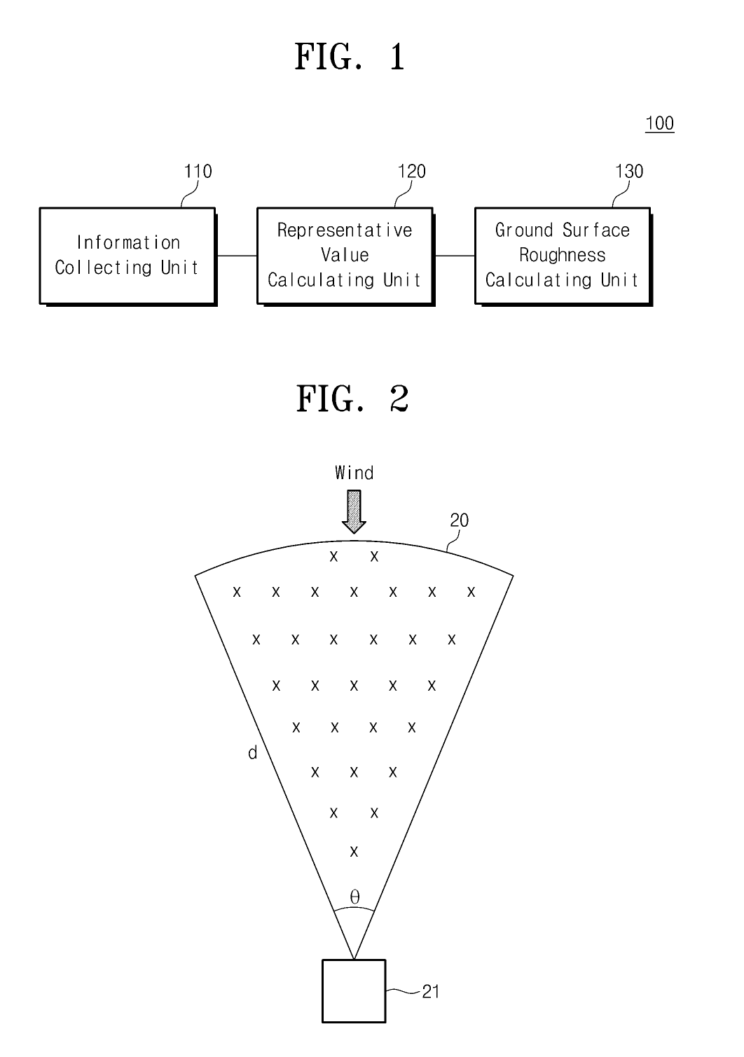

FIG. 1 is a block diagram of a ground surface roughness calculating apparatus according to an embodiment of the present invention.

As shown in FIG. 1, a ground surface roughness calculating apparatus 100 may include an information collecting unit 110, a representative value calculating unit 120, and a ground surface roughness calculating unit 130. The information collecting unit 110 may collect height information on a plurality of points in a region. In this example, the region is one considered when calculating wind load and may be located around a structure.

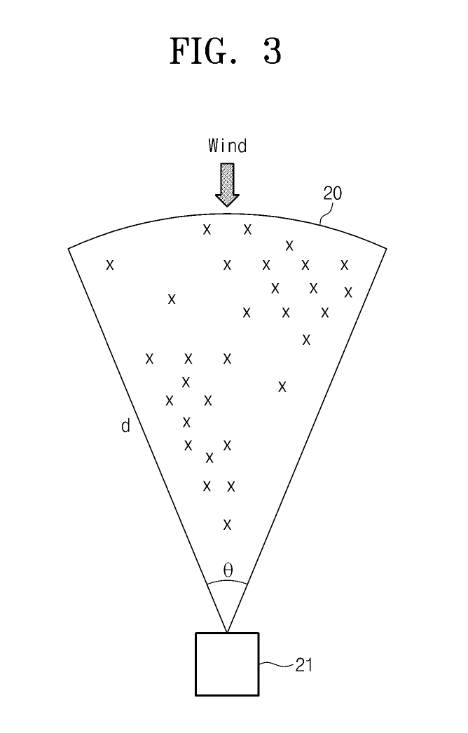

FIGS. 2 and 3 illustrate a region considered when calculating wind load and a plurality of points in the region from which height information is collected according to an embodiment of the present invention. As shown in FIGS. 2 and 3, a region 20 may have a sector shape in which the region is halved by a windward line on the structure 21. The central angle θ of the sector may be 45° but may have a smaller or greater angle than that depending on the embodiment. The radius d of the sector may have a smaller one of 40 times the reference height H of the structure 21 and 3 km.

Unlike FIGS. 2 and 3, the region 20 may be a circle that has a radius of d. However, the region 20 is not be limited thereto but may have a polygon or any shape.

The information collecting unit 110 may collect height information on a plurality of points (indicated by x in FIGS. 2 and 3) in the region 20.

As shown in FIG. 2, according to an embodiment of the present invention, the points may be uniformly distributed in the region 20. However, as shown in FIG. 3, according to another embodiment of the present invention, the points may be non-uniformly distributed in the region 20.

According to an embodiment of the present invention, the information collecting unit 110 may collect height information on the points from the digital map of the region 20. According to an embodiment, data on the digital map may be stored in a storage unit that is included in the ground surface roughness calculating apparatus 100. In this case, the information collecting unit 110 may read data on the digital map from the storage unit and collect height information on the points in a region 20.

According to another embodiment, data on the digital map may be stored in a server connected to the ground surface roughness calculating apparatus 100 through a network or in an external storage device. In this case, the information collecting unit 110 may read data on the digital map from the server or the external storage device through the network or a data interface and collect height information on the points in the region 20.

According to an embodiment of the present invention, the information collecting unit 110 may use at least one of ground survey, GPS survey, aerial photogrammetry, radar survey, and LiDAR survey to collect height information on the points from the data surveyed on the region 20.

According to an embodiment of the present invention, the points in the region 20 may also correspond to a building located in the region. According to an embodiment, the points in the region 20 may also 1:1 correspond to buildings located in the region. When a point in the region 20 is located at a building, the information collecting unit 110 may calculate the height of the building as the height the point.

According to another embodiment, some of the points in the region 20 may also correspond to the ground or the water surface where there is no building. When a point in the region 20 is located at the ground or the water surface, the information collecting unit 110 may calculate the height of a corresponding point as 0.

According to an embodiment of the present invention, the information collecting unit 110 may extract a building, an elevation point and a reference point from the digital map of the region. In addition, it is possible to extract a panel point at the central part or outline of a building from the extracted building and generate a point where the generated panel point 1:1 corresponds to the reference point and the elevation point located on the ground. In addition, the height of the point located on the building may be calculated as the height of the building and the height of the point located on the ground may be calculated as 0.

According to an embodiment of the present invention, the height of the building may be calculated as follows. That is, height information on a corresponding point may be obtained by multiplying the number of non-basement stories of the building by a preset height. The height multiplied with the number of non-basement stories of the building may be 3 m. However, the height is not limited thereto but may also be set more highly or lowly than 3 m.

According to an embodiment of the present invention, the information collecting unit 110 may perform filtering on 3D point data collected by using at least one of ground survey, GPS survey, aerial photogrammetry, radar survey, and LiDAR survey on the region to extract data on a building and the ground, generate a point 1:1 corresponding to the extracted data on the building and the ground, calculate the height of the point located on the building as the height of the building and calculate the height of the point located on the ground as 0.

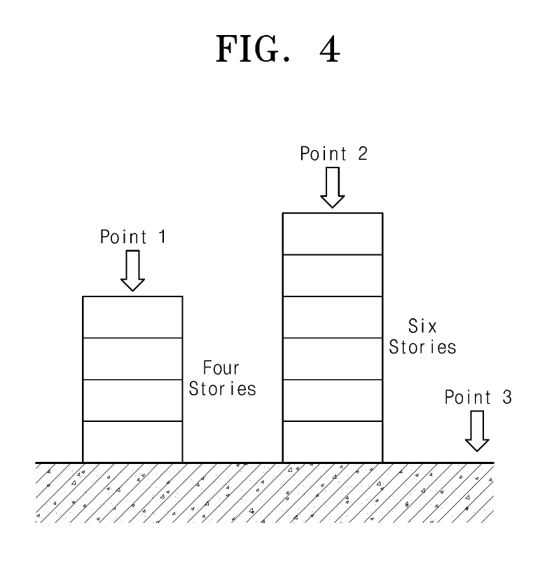

FIG. 4 illustrates a process of obtaining height information on a plurality of points in the region 20 according to an embodiment of the present invention.

Referring to FIG. 4, when a building is located on point 1 of the points in the region 20, the information collecting unit 110 may collect information on the number of non-basement stories of the building. The number of non-basement stories of the building located on the point 1 in FIG. 4 is four. The information collecting unit 110 may obtain height information on a corresponding point by multiplying the number of non-basement stories of the building by a preset height (e.g., 3 m). In this case, the height of the point 1 shown in FIG. 4 may be calculated as 12 m. Likewise, the height of point 2 may be calculated as 18 m and the height of point 3 may be calculated as 0.

The representative value calculating unit 120 may calculate the representative value of the region 20 by using statistical data on height information on the points.

According to an embodiment, the representative value calculating unit 120 may calculate the median of the heights of the points to determine the calculated value as the representative value of the region 20. According to another embodiment, the representative value calculating unit 120 may calculate the maximum value of the heights of the points to determine the calculated value as the representative value of the region 20. According to another embodiment, the representative value calculating unit 120 may calculate the maximum frequency of the heights of the points to determine the calculated maximum frequency as the representative value of the region 20.

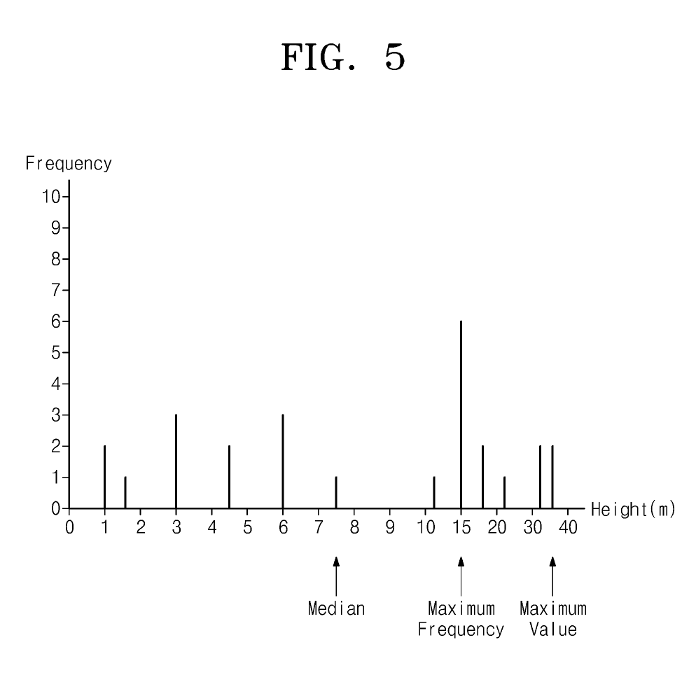

FIG. 5 is a graph of a plurality of points in the region 20 according to an embodiment of the present invention, the points being represented in height order.

Referring to FIG. 5, the height of the intermediate one of the points in the region 20 is 7.5 m. Also, the height of the highest one of the points in the region 20 is 36 m. Also, the height of a point having the maximum frequency among the points in the region 20 is 15 m.

As such, according to an embodiment of the present invention, the representative value calculating unit 120 may calculate any one of the median, maximum value, and maximum frequency of the heights of the points by using statistical data on the heights of the points in the region 20 to determine the calculated value as the representative value of the region 20.

According to another embodiment, the representative value calculating unit 120 may calculate the mean value of the heights of the points to determine the calculated value as the representative value. The mean value may be any one of the arithmetic mean, the geometric mean, and the harmonic mean. According to another embodiment of the present invention, the representative value calculating unit 120 may calculate a frequency distribution for the heights of the points and determine the rank value of a rank having the maximum frequency on the frequency distribution, as the representative value of the region 20.

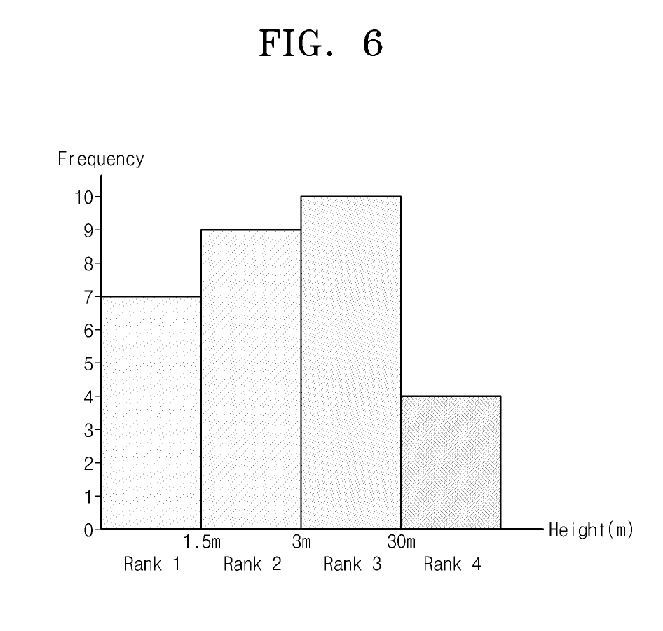

FIG. 6 is an exemplary frequency distribution graph that represents the frequency distribution of the heights of a plurality of points in a region produced according to an embodiment of the present invention.

As shown in FIG. 6, the representative value calculating unit 120 may classify the heights of the points into a plurality of ranks and then calculate the frequencies of points belonging to each rank to calculate a grouped frequency distribution.

According to an embodiment, the representative value calculating unit 120 may classify height information on the points collected from the region 20 into four ranks. However, the present invention is not limited thereto but may also classify the height information into ranks less or more than four.

According to an embodiment, the number of ranks may match with the number of classes of ground surface roughness For example, when the ground surface roughness is classified into four ranks, the representative value calculating unit 120 may calculate a frequency distribution on which the heights of the points are grouped into four classes.

The representative value calculating unit 120 may determine the rank value of a rank having the maximum frequency on the frequency distribution, as the representative value of the region 20. For example, on the frequency distribution graph shown in FIG. 6, the rank having the maximum frequency is rank 3 and the rank value of the rank 3 may be 16.5 m that is the intermediate value of the rank. Thus, the representative value calculating unit 120 may determine 16.5 m, the rank value of the rank 3, as the representative value of the region 20.

The ground surface roughness calculating unit 130 may calculate the ground surface roughness of the region 20 according to the representative value. According to an embodiment of the present invention, the ground surface roughness calculating unit 130 may compare the representative value with a reference range set for ground surface roughness and calculate the ground surface roughness of the region 20 based on the comparison result.

For example, the ground surface roughness may be classified into four groups A to D and the following reference range may be set to each ground surface roughness. In this example, the ground surface is rough in order of ground surface roughness A to D (that is, A>B>C>D in ground surface roughness).

| | Ground surface roughness | | | |
|---|---|---|---|---|
| | A | B | C | D |
| Reference | Equal to | Equal to | Equal to | Lower |
| range | or higher | or higher 3 m | or higher 1.5 m | than |
| | than 30 m | and lower | and lower | 1.5 m |
| | | than 30 m | than 3 m | |

In this case, the ground surface roughness calculating unit 130 may compare the representative value of the region 20 with a reference range set for each ground surface roughness and calculate the ground surface roughness of a reference range to which the representative value belongs, as the ground surface roughness of the region 20. For example, when the representative value of the region 20 is calculated as 16.5 m, the ground surface roughness calculating unit 130 may determine the ground surface roughness of the region 20 as B.

The information collecting unit 110, the representative value calculating unit 120, and the ground surface roughness calculating unit 130 that are described above may be configured as a processor, such as CPU that executes a program for calculating ground surface roughness and performs a ground surface roughness calculating operation. Also, the program for calculating the ground surface roughness may be stored in a storage unit such as a memory, and the ground surface roughness calculating apparatus 100 may call and execute the program from the storage unit.

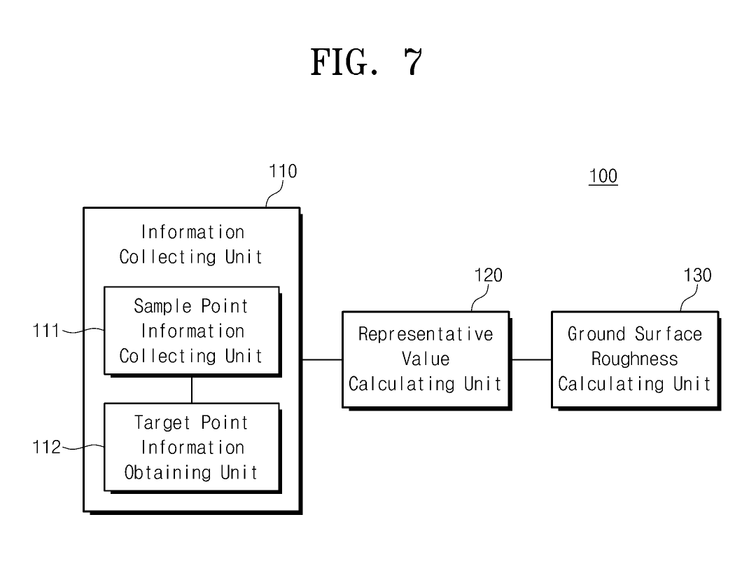

FIG. 7 is an exemplary block diagram of a ground surface roughness calculating apparatus according to another embodiment of the present invention.

As shown in FIG. 7, the information collecting unit 110 may include sample point information collecting unit 111 and a target point information obtaining unit 112. The sample point information collecting unit 111 may collect height information on a plurality of sample points in the region 20. The target point information obtaining unit 112 may use height information on the sample points to obtain height information on a plurality of target points in the region 20.

According to an embodiment of the present invention, the sample point height information collecting unit 111 may extract a building from the digital map of the region 20 and allocate a sample point to the extracted building. Also, the sample point height information collecting unit 111 may extract at least one of an elevation point and a reference point from the digital map of the region 20 and allocate the extracted one of the elevation point and reference point as a sample point.

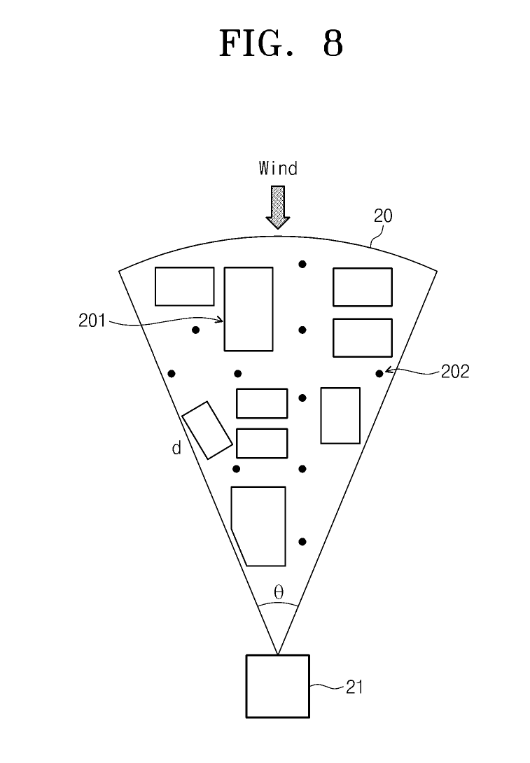

FIG. 8 is an exemplary plane view of a region considered when calculating wind load and a building included in the region according to another embodiment of the present invention.

Referring to FIG. 8, the sample point height information collecting unit 111 may extract an object corresponding to the building 201 from the digital map of the region 20 and extract an elevation point 202 located on the ground or the water surface. According to an embodiment, the sample point height information collecting unit 111 may extract the reference point of the digital map instead of the elevation point 202 or extract both the elevation point and the reference point.

Then, the sample point height information collecting unit 111 may allocate a sample point to the building, the elevation point, and the reference point that are extracted. According to an embodiment of the present invention, the sample point height information collecting unit 111 may allocate the sample point to the central part of the extracted building.

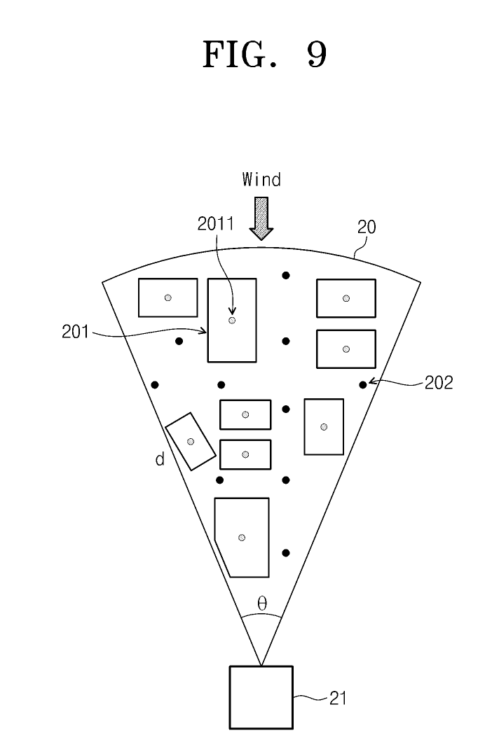

FIG. 9 illustrates the central part of the building 201 included in the region 20 according to an embodiment of the present invention.

As shown in FIG. 9, the sample point height information collecting unit 111 may allocate the sample point to the central part 2011 of the building 201 extracted from the digital map of the region 20.

According to another embodiment of the present invention, the sample point height information collecting unit 111 may extract a panel point from the outline of the extracted building and allocate the extracted panel point as the sample point.

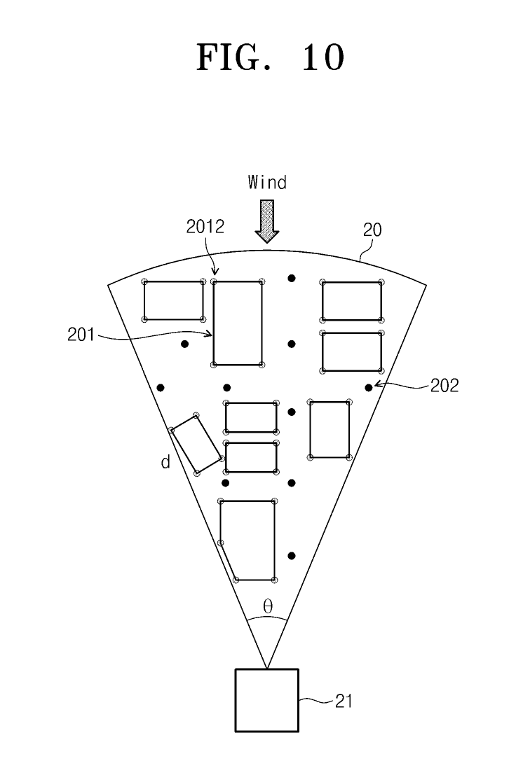

FIG. 10 illustrates a panel point obtained from the outline of the building 201 included in the region 20 according to an embodiment of the present invention.

As shown in FIG. 10, the sample point height information collecting unit 111 may extract panel points 2012 from the outline of the building 201 extracted from the digital map of the region 20 and allocate the extracted panel points as sample points. According to an embodiment, the panel points 2012 may correspond to the corners of a polygon that includes the outline of the building 201.

As such, the sample point height information collecting unit 111 may extract the building 201 and the elevation point 202 from the digital map of the region 20 and allocate sample points to the extracted building 201 and the extracted elevation point 202. The sample point may correspond to the central part 2011 of the building 201 or panel points 2012 obtained from the outline of the building 201, or may correspond to both the central part of the building and the panel point depending on the embodiment.

According to an embodiment of the present invention, when the sample point is located on the building 201, the sample point height information collecting unit 111 may calculate the height of a corresponding building as the height of a sample point. In the present embodiment, the sample point height information collecting unit 111 may collect information on the number of non-basement stories of the building 201 on which the sample point is located, and calculate the height of a corresponding building by multiplying the number of non-basement stories of the building by a preset height. The height multiplied with the number of non-basement stories may be 3 m. However, the height is not limited thereto but may also be lower or higher than 3 m.

According to an embodiment of the present invention, when the sample point is located on the ground or the water surface, the sample point height information collecting unit 111 may calculate the height of a corresponding sample point as 0. In other words, when the sample point is located on the ground or the water surface such as earth, river, lake, or sea, instead of a building, the height of the sample point may be calculated as 0.

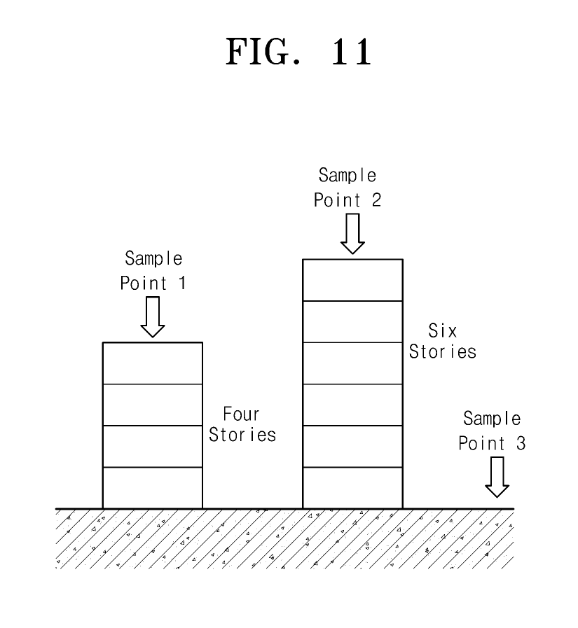

FIG. 11 illustrates a process of obtaining height information on a plurality of sample points in the region 20 according to an embodiment of the present invention.

As shown in FIG. 11, when sample point 1 is among the sample points in the region 20 is located on a building, the information collecting unit 111 may collect information on the number of non-basement stories of a corresponding building. In FIG. 11, the number of non-basement stories of a building where the sample point 1 is located 4 is four. The sample point height information collecting unit 111 may multiply the number of non-basement stories of the building by a preset height (e.g., 3 m) to obtain height information on a corresponding sample point. In this case, the height of the sample point 1 shown in FIG. 11 may be calculated as 12 m. Likewise, the height of sample point 2 may be calculated as 18 m.

As further shown in FIG. 11, when sample point 3 among the sample points in the region 20 is located on the ground, the information collecting unit 111 may calculate the height of a corresponding sample point as 0.

As described above, according to an embodiment of the present invention, the sample point height information collecting unit 111 may use the digital map of the region 20 to collect height information on a sample point but according to another embodiment, the sample point height information collecting unit 111 may also use survey data on the region 20 obtained by using at least one of ground survey, GPS survey, aerial photogrammetry, radar survey, and LiDAR survey to collect height information on a sample point.

According to an embodiment of the present invention, the information collecting unit 111 may perform filtering on 3D point data collected by using at least one of ground survey, GPS survey, aerial photogrammetry, radar survey, and LiDAR survey to extract data on a building and the ground, generate a point 1:1 corresponding to the extracted data on the building and the ground, calculate the height of the point located on the building as the height of the building and calculate the height of the point located on the ground as 0. In addition, the sample point height information collecting unit 111 may calculate the height of a sample point located on a building as the height of the building, and calculate the height of a sample point located on the ground or the water surface as 0.

Referring back to FIG. 7, the target point height information obtaining unit 112 may use height information on the sample point to obtain height information on a plurality of target points in a region. In this example, the target point is one considered to calculate a parameter used for calculating the wind load of a region and according to an embodiment of the present invention, the parameter may be calculated based on height information on the target point.

According to an embodiment of the present invention, the target point height information collecting unit 112 may use height information collected on the sample point to create a digital elevation model (DEM). Then, it is possible to create a plurality of target points corresponding to the grid of the DEM and calculate the height of the grid of the DEM as height information on a target point corresponding to the grid.

According to an embodiment, the target point height information obtaining unit 112 may allocate a point in the grid of the DEM as a target point. According to an embodiment, the target point height information obtaining unit 112 may allocate the central part of the grid of the DEM as a target point.

According to another embodiment of the present invention, the target point height information collecting unit 112 may create a plurality of target points in the region (see FIG. 2) and use interpolation based on height information collected on the sample point to calculate height information on a target point.

According to an embodiment, the target point height information obtaining unit 112 may use linear, non-linear or natural neighbor interpolation to calculate height information on a target point but used interpolation is not limited thereto.

According to another embodiment of the present invention, the information collecting unit 110 may collect information on the height and area of a building in the region. In addition, the representative value calculating unit 120 may apply the area of the building as weight to the height of the building to calculate a weighted average height. In the present embodiment, the weighted average height may be used as the representative value of a region.

The information collecting unit 110 may collect area information on the building from data obtained by surveying the digital map of the region 20 or the region.

The area of the building may be any one of the building area of a building or the area of a lot on which a building is located.

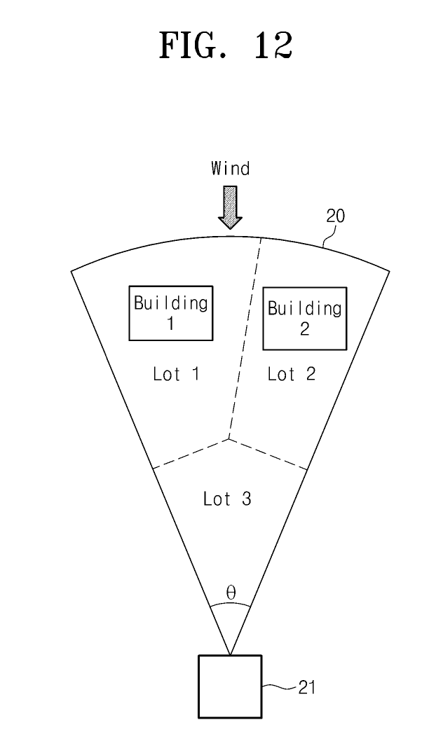

FIG. 12 illustrates a process of calculating a weighted average height according to another embodiment of the present invention.

Referring to FIG. 12, when the height of building 1 located in the region 20 is 40 m, the building area of the building 1 is 10 m2, the height of building 2 is 20 m, and the building area of the building 2 is 30 m2, it is possible to apply the building area of a building as weight to the height of a building and find a weighted average height as follows.

(40×10+20×30)/(10+30)=25.

As such, the representative value calculating unit 120 may apply the area of the building as weight to the height of the building located in the region 20 to calculate the weighted average height of the building located in the region as 25 m.

According to another embodiment, the representative value calculating unit 120 may apply, as weight, the area of a lot on which the building is located, to calculate a weighted average height.

Referring to FIG. 12, when the height of building 1 in the region 20 is 40 m, the area of lot 1 on which the building 1 is located is 30 m², the height of building 2 is 20 m, the area of lot 2 on which the building 2 is located 40 m², and the area of lot 3 on which there is no building is 30 m², a weighted average height may be found by applying, as weight, the area of lots on which buildings are located, in the following way:

(40×30+20×40+0×30)/(30+40+30)=20.

As such, the representative value calculating unit 120 may apply, as weight, the area of a lot on which a building is located, to calculate the weighted average height of the building located in a region as 20 m.

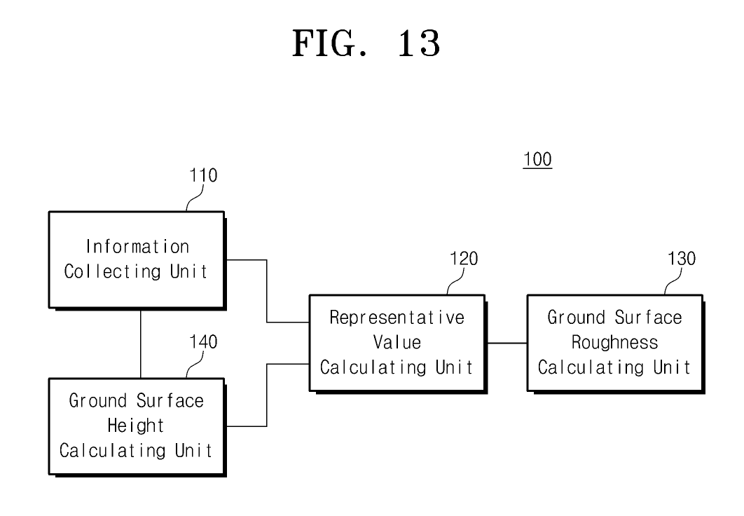

FIG. 13 is an exemplary block diagram of a ground surface roughness calculating apparatus 100 according to another embodiment of the present invention.

Referring to FIG. 13, the information collecting unit 110 may collect elevation information on a plurality of points in a region and total-height information that the height of a building is reflected to an elevation. In addition, the ground surface roughness calculating apparatus 100 may further include a ground surface height calculating unit 140 that calculates the ground surface height of a region based on the elevation information. In addition, the representative value calculating unit 120 may calculate the representative value of a region by using statistical data on the difference value between a total height calculated for each point and the ground surface height.

When a point is located on a building, the information obtaining unit 110 may add the height of a building to the elevation of the ground to calculate the total height of a corresponding point. Also, when a point is located on the ground or the water surface, the information obtaining unit 110 may calculate the elevation of the ground or the water surface as the total height of a corresponding point.

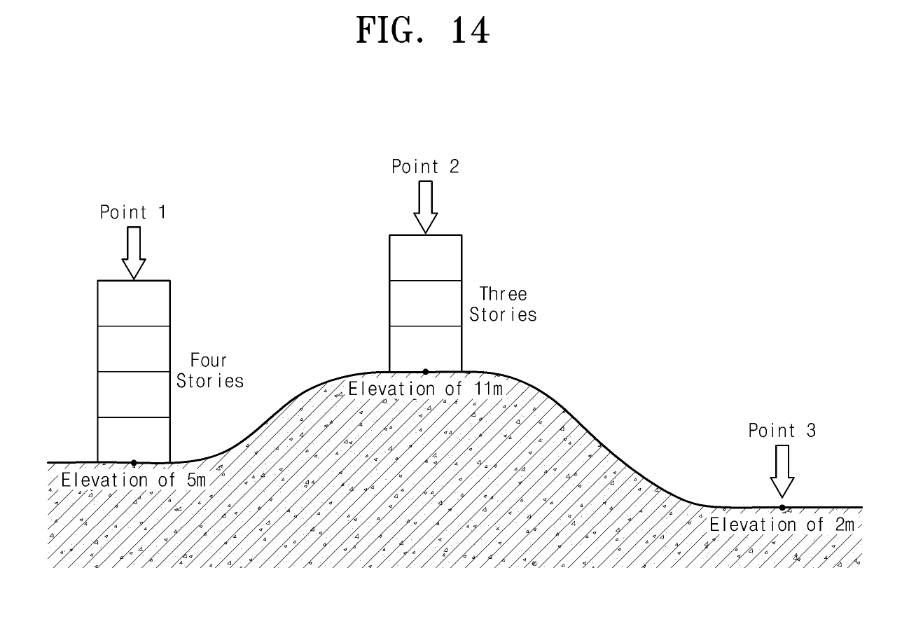

FIG. 14 illustrates a process of obtaining elevation information and total-height information on a plurality of points according to an embodiment of the present invention.

Referring to FIG. 14, since point 1 is located on a building, the total height of the point 1 may be calculated as 17 m that is obtained by adding the elevation of the ground, 5 m, to the height of the building, 12 m calculated by multiplying the number of non-basement stories of the building, 4, by 3 m.

Likewise, since point 2 is also located on a building, the total height of the point 2 may be calculated as 20 m that is obtained by adding the elevation of the ground, 11 m, to the height of the building, 9 m calculated by multiplying the number of non-basement stories of the building, 3, by 3 m.

On the contrary, since point 3 is located on the ground where there is no building, the total height of the point 3 may be calculated as the elevation of the ground, 2 m.

The ground surface height calculating unit 140 may calculate the ground surface height of the region 20 based on elevation information on the points.

According to an embodiment of the present invention, the ground surface height calculating unit 140 may calculate the minimum value or maximum frequency of the elevations of the points as the ground surface height.

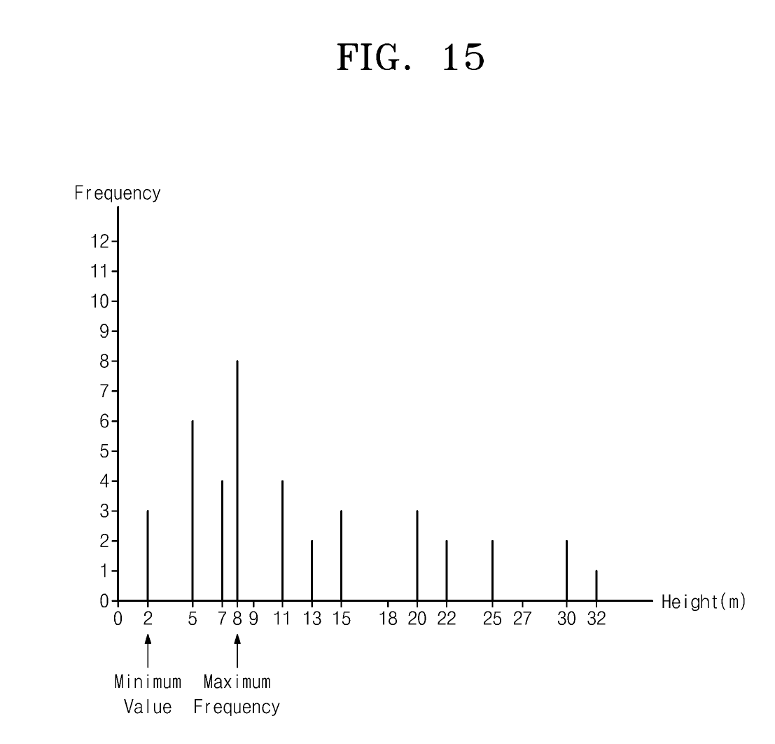

FIG. 15 is an exemplary graph of a plurality of points in the region 20 according to an embodiment of the present invention, the points being represented in elevation order.

According to an embodiment shown in FIG. 15, the minimum value of the elevations of a plurality of points collected from the region 20 is 2 m and the maximum frequency thereof is 8 m. According to an embodiment, the ground surface height calculating unit 140 may calculate 2 m corresponding to the minimum value of the elevations of the points as the ground surface height of the region 20. According to another embodiment, the ground surface height calculating unit 140 may calculate 8 m corresponding to the maximum frequency of the elevations of the points as the ground surface height of the region 20.

According to another embodiment of the present invention, the ground surface height calculating unit 140 may calculate a frequency distribution for the elevations of a plurality of points and calculate the rank value of a rank having the maximum frequency as the ground surface height of the region 20.

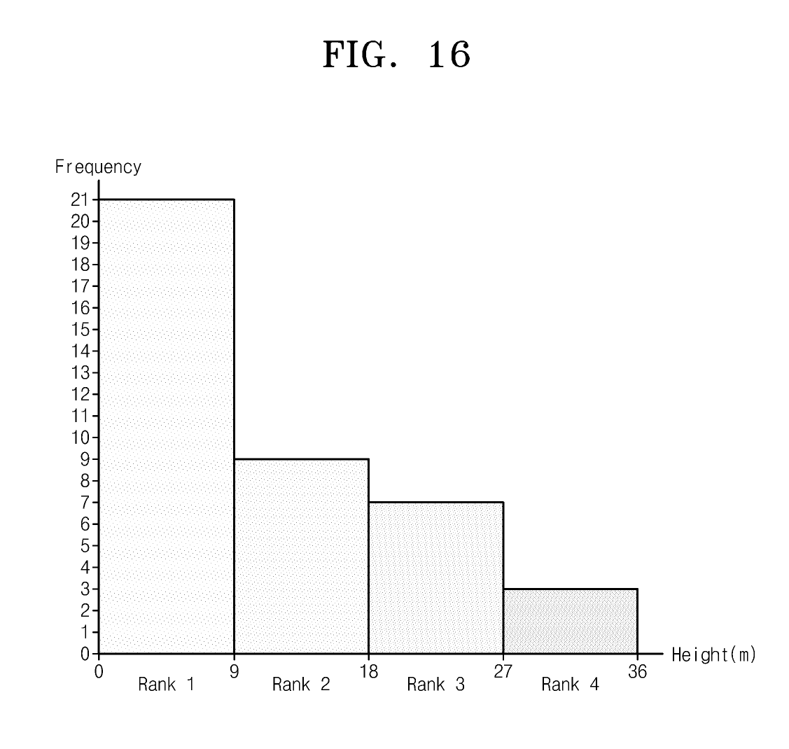

FIG. 16 is an exemplary frequency distribution graph representing the frequency distribution of the elevations of a plurality of points in the region 20 according to an embodiment of the present invention.

Referring to FIG. 16, the ground surface height calculating unit 140 may calculate the rank value of rank 1, 4.5 as the ground surface height of the region 20. The rank 1 has the maximum frequency on the frequency distribution of the elevations of a plurality of points.

According to an embodiment, the ground surface height calculating unit 140 may also calculate the mean value of elevations belonging to a rank having the maximum frequency on a frequency distribution, as the ground surface height of the region 20. For example, in the embodiment of FIG. 16, the ground surface height calculating unit 140 may calculate the mean value of elevations belonging to rank 1 having the maximum frequency to determine the calculated value as the ground surface height of the region 20.

According to an embodiment, the ground surface height calculating unit 140 may calculate the rank value of a rank having the minimum frequency on a frequency distribution, as the ground surface height of the region 20. According to an embodiment, the ground surface height calculating unit 140 may also calculate the mean value of elevations belonging to a rank having the minimum frequency on a frequency distribution, as the ground surface height of the region 20.

In this example, the mean value may be the arithmetic mean, geometric mean or harmonic mean of elevations, and depending on the embodiment, the mean value may be a weighted average value that the frequency of an elevation is applied to the elevation as weight.

Although the frequency distribution graph shown in FIG. 16 sets the size of a rank to 9 m, the size of the rank is not limited thereto but may be set to be shorter or longer than 9 m. Also, although the frequency distribution graph shown in FIG. 16 equally sets the size of each rank, the size of each rank configuring a frequency distribution may also be differently set depending on the embodiment.

Then, the representative value calculating unit 120 may calculate the difference value between a total height and a ground surface height for each point and calculate the representative value of the region 20 by using statistical data on the difference value.

According to another embodiment of the present invention, the information collecting unit 110 may further collect location information on a plurality of points in the region 20. In addition, the ground surface height calculating unit 140 may use regression analysis based on location information and elevation information on a point to calculate a regression equation and apply location information on the point to the regression equation to calculate a ground surface height for each point.

In this example, the location information on the point may include an absolute coordinate including latitude and longitude data on the point but also include a relative coordinate based on any point depending on the embodiment. The location information on the point may be collected from the digital map of the region 20 or may also be collected from data obtained by surveying the region 20 depending on the embodiment.

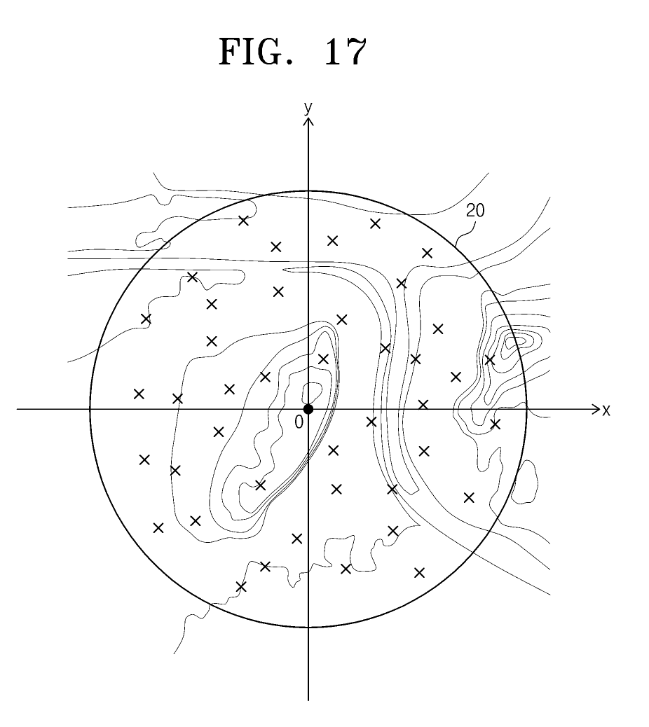

FIG. 17 illustrates a process of obtaining location information on a plurality of points X according to an embodiment of the present invention.

As shown in FIG. 17, the location of the points X may be represented as a 2D orthogonal coordinate of which the standing point is the central part 21 of the region 20. In this case, the coordinate x and y of the points X may be determined according to distance and direction from the standing point.

Although in FIG. 17, the standing point of the coordinate is set to be the central part 21 of the region 20, the location of the standing point is not limited thereto but may be set to be any point located inside or outside the region 20.

The ground surface height calculating unit 140 may use regression analysis to calculate regression equation based on location information and elevation information on a point.

According to an embodiment of the present invention, the ground surface height calculating unit 140 may calculate regression equation based on location information and elevation information on some of a plurality points. In other words, the ground surface height calculating unit 140 may perform regression analysis only on some of the points.

According to an embodiment, the ground surface height calculating unit 140 may calculate a regression equation based on location information and elevation information on a predetermined number of points or a predetermined percentage of points among the plurality of points.

According to another embodiment, the ground surface height calculating unit 140 may use a frequency distribution to select a point to be used for regression analysis among the points.

For example, the ground surface height calculating unit 140 may calculate a frequency distribution for the elevations of the points, select a point having an elevation belonging to a rank having the maximum frequency from the frequency distribution, and calculate a regression equation based on location information and elevation information on the selected point.

According to another embodiment, the ground surface height calculating unit 140 may select a point having an elevation belonging to the lowest rank from the frequency distribution and calculate a regression equation based on location information and elevation information on the selected point.

The ground surface height calculating unit 140 may set location information on a point as an independent variable and elevation information on a point as a dependent variable to calculate a regression equation.

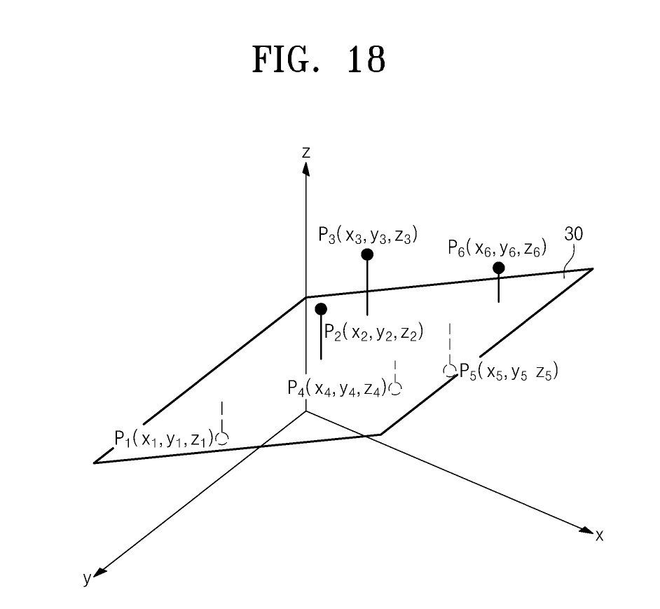

FIG. 18 illustrates a process of producing a regression equation based on location information and elevation information on a point according to another embodiment of the present invention.

As shown in FIG. 18, according to an embodiment of the present invention, the ground surface height calculating unit 140 may perform regression analysis on location and elevation information x, y and z on points P₁ to P₆ and calculate the following regression equation:

Zᵢ=a₀+a₁Xᵢ+a₂yᵢ+eᵢ

The regression equation may be one representing a plane 30 shown in FIG. 18.

According to an embodiment, the ground surface height calculating unit 140 may calculate a₀, a₁, and a₂ that minimizes the sum of the square of an error eᵢ as below:

$${S}_{r} = {\sum }_{i = 1}^{n} {( {z}_{i} - {a}_{0} - {a}_{1} {x}_{i} - {a}_{2} {y}_{i} )}^{2}$$

To that end, the ground surface height calculating unit 140 may perform partial differentiation on Sᵣ by using each of unknown quantities a₀, a₁ and a₂ to find simultaneous equations as below:

$$\frac{\partial {S}_{r}}{\partial {a}_{0}} = - 2 Σ ( {z}_{i} - {a}_{0} - {a}_{1} {x}_{i} - {a}_{2} {y}_{i} ) = 0$$

$$\frac{\partial {S}_{r}}{\partial {a}_{1}} = - 2 Σ {x}_{i} ( {z}_{i} - {a}_{0} - {a}_{1} {x}_{i} - {a}_{2} {y}_{i} ) = 0$$

$$\frac{\partial {S}_{r}}{\partial {a}_{2}} = - 2 Σ {y}_{i} ( {z}_{i} - {a}_{0} - {a}_{1} {x}_{i} - {a}_{2} {y}_{i} ) = 0$$

Then, it is possible to calculate a₀, a₁, and a₂ by finding the solutions of the simultaneous equations.

As an example, when location and elevation information x, y, and z on points P₁ to P₆ is provided as P₁ (0, 0, 5), P₂ (2, 1, 10), P₃ (2.5, 2, 9), P₄ (1, 3, 0), P₅ (4, 6, 3), and P₆ (7, 2, 27), then a₀=5, a₁=4, and a₂=−3.

Thus, a planar equation obtained by performing regression analysis on the points P₁ to P₆ is as follows: z=5+4x−3y.

As such, the ground surface height calculating unit 140 may set location information x and y on points P₁ to P₆ as an independent variable and elevation information z as a dependent variable to calculate a regression equation. The calculated regression equation may be used for calculating a ground surface height for each of a plurality of points as will be described.

Then, the ground surface height calculating unit 140 may apply location information x and y on a point to the regression equation to calculate a ground surface height for each of a plurality of points.

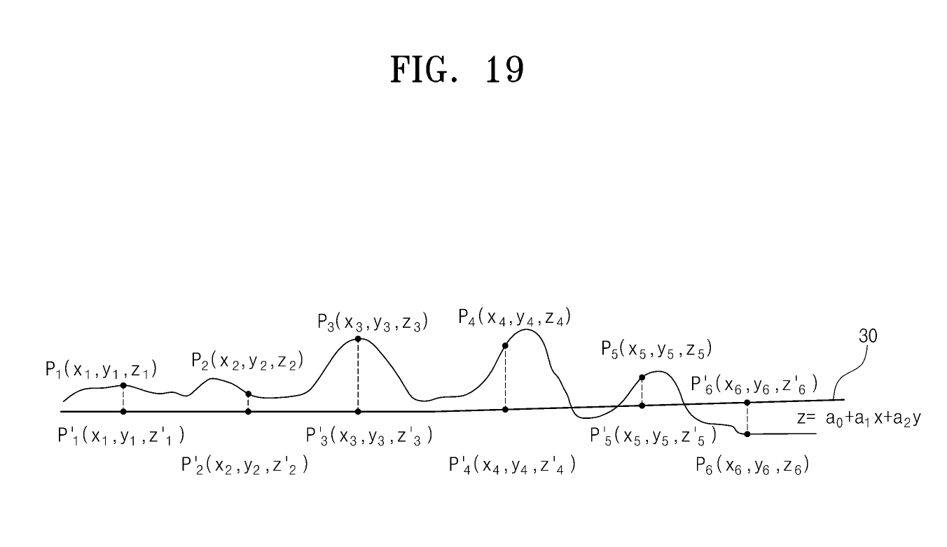

FIG. 19 illustrates a process of calculating the ground surface height of each point by using a regression equation according to another embodiment of the present invention.

According to an embodiment, a regression equation calculated based on location and elevation information on some points may be considered as representing the ground surface of the region 20, and thus the ground surface height calculating unit 140 may apply location information on each of a plurality of points to the regression equation to fine the height of the ground surface for each point.

For example, as shown in FIG. 19, the ground surface height calculating unit 140 may apply location information x and y on each point to the regression equation, Zᵢ=a₀+a₁x+a₂y, to calculate a ground surface height z for each point. Since an embodiment of the present invention considers that the plane 30 indicated by a regression equation corresponds to the ground surface of the region 20, the height z obtained by applying location information x and y on each point P₁ to P₆ to the regression equation may correspond to a ground surface height of each point.

Although embodiments shown in FIGS. 18 and 19 calculate the ground surface height of each point by using a regression equation representing the plane 30, it is also possible to calculate the ground surface height of each point by calculating a regression equation representing a curved surface instead of a plane.

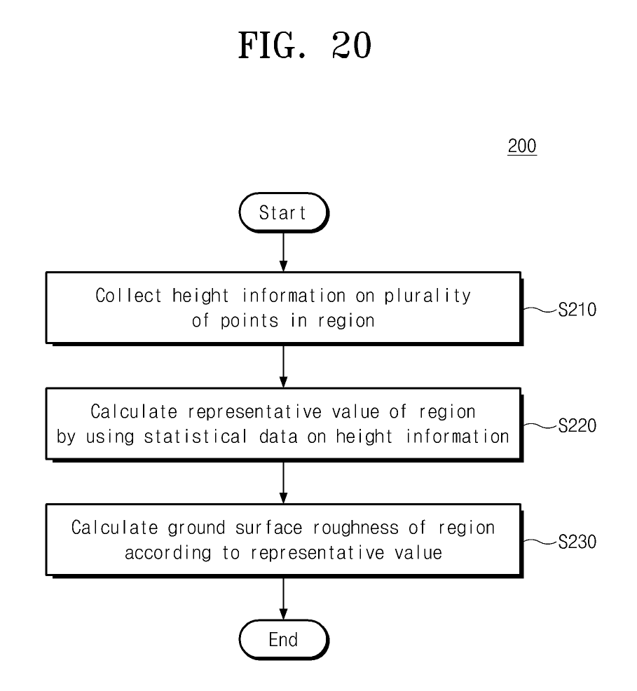

FIG. 20 is a flow chart of a ground surface roughness calculating method according to an embodiment of the present invention.

A method for calculating ground surface roughness according to an embodiment of the present invention may collect the ground surface roughness of a region based on a representative value that is obtained by using statistical data on height information on a plurality of points in the region. The ground surface roughness calculating method may be performed by the ground surface roughness calculating apparatus 100 according to an embodiment of the present invention as described above.

As shown in FIG. 20, the ground surface roughness calculating method 200 may include collecting height information on a plurality of points in a region in step S210, calculating the representative value of the region by using statistical data on the height information in step S220, and calculating the ground surface roughness of the region according to the representative value in step S230.

According to an embodiment of the present invention, the collecting of the information in step S210 may include collecting the height information from the digital map of the region 20.

Data on the digital data may be stored in a storage unit included in the ground surface roughness calculating apparatus 100 according to an embodiment of the present invention, may be stored in an external storage device connected to the ground surface roughness calculating apparatus 100, or may be stored in a server connected to the ground surface roughness calculating apparatus 100 through a network.

According to an embodiment of the present invention, the collecting of the information in step S210 may include collecting the height information on the points from data surveyed on the region 20 by using at least one of ground survey, GPS survey, aerial photogrammetry, radar survey, and LiDAR survey.

According to an embodiment of the present invention, the points in the region 20 may also correspond to buildings located in the region. According to an embodiment, when a point in the region 20 is located at a building, the collecting of the information in step S210 may calculate the height of the building as the height of the point.

On the contrary, some of the points in the region 20 may also correspond to the ground or the water surface where there is no building. According to an embodiment, when a point in the region 20 is located on the ground or the water surface, the collecting of the information in step S210 may calculate the height of the building as 0.

According to an embodiment, the collecting of the information in step S210 may include extracting a building, an elevation point, and a reference point from the digital map of the region, extracting panel points from the outline or central part of the building from the extracted building to create a point that 1:1 corresponds to the panel points and the elevation point and reference point located on the ground, calculating the height of a point located on a building as the height of the building, and calculating the height of a point located on the ground as 0.

According to an embodiment of the present invention, the height of the building may be calculated by multiplying the number of non-basement stories of the building by a preset height. Although the height multiplied by the number of non-basement stories of the building may be 3 m. However, the height is not limited thereto but may also be set more highly or lowly than 3 m.

According to an embodiment of the present invention, the collecting of the information in step S210 may perform filtering on 3D point data collected by using at least one of ground survey, GPS survey, aerial photogrammetry, radar survey, and LiDAR survey on the region to extract building and ground data, creating a point 1:1 corresponding to the extracted building and ground data, calculating the height of a point located on a building as the height of the building and collecting the height of a point located on the ground as 0.

According to an embodiment of the present invention, the calculating of the representative value of the region in step S220 may include calculating a median of the heights of the points.

According to another embodiment of the present invention, the calculating of the representative value of the region in step S220 may include calculating the maximum value of the heights of the points. According to another embodiment, the calculating of the representative value of the region in step S220 may include calculating the maximum frequency of the heights of the points.

According to an embodiment of the present invention, the calculating of the representative value of the region in step S220 may include calculating a mean value of the heights of the points. The mean value may be any one of the arithmetic mean, the geometric mean, and the harmonic mean.

The median, maximum value, maximum frequency, or mean value that are calculated as above may be determined as the representative value of the region 20.

According to another embodiment of the present invention, the calculating of the representative value of the region in step S220 may include calculating a frequency distribution for the heights of the points and determining the rank value of a rank having the maximum frequency on the frequency distribution as the representative value of the region 20.

In the present embodiment, the number or ranks configuring the frequency distribution may be the same as that of ranks for ground surface roughness. However, the number is not limited thereto but may also be less or more than that of ranks for ground surface roughness.

According to an embodiment of the present invention, the calculating of the ground surface roughness of the region in step S230 may include comparing the representative value of a region with a reference range set for each ground surface roughness, and calculating the ground surface roughness of the reference range to which the representative value belongs, as the ground surface roughness of the region 20.

According to another embodiment of the present invention, the collecting of the information in step S210 may include collecting height information on a plurality of sample points in the region 20, and obtaining height information on a plurality of target points in the region 20 by using height information on the sample points.

According to an embodiment, the obtaining of the height information on the target point may include creating a DEM by using height information on the collected sample point, creating a plurality of target points corresponding to the grid of the DEM, and calculating the height of the grid of the DEM as height information on a target point corresponding to the grid.

According to another embodiment, the obtaining of the height information on the target point may include creating a plurality of target points in the region 20 and calculating height information on the target point by using interpolation based on the height information collected on the sample point.

According to another embodiment of the present invention, the collecting of the height information on the point in step S210 may include collecting information on the height and area of a building in the region 20. In addition, the calculating of the representative value in step S220 may include applying the area of the building as weight to the height of the building to calculate a weighted average height.

According to another embodiment of the present invention, the collecting of the height information on the point in step S210 may include collecting elevation information on a plurality of points in the region 20 and total-height information that the height of a building is reflected to an elevation.

In addition, the ground surface roughness calculating method 200 may further include calculating the ground surface height of the region 20 based on the elevation information.

In addition, the calculating of the representative value may include calculating the representative value of the region 20 by using statistical data on the difference value between a total height calculated for each point and the ground surface height.

According to the present embodiment, when the point is located on a building, it is possible to add the height of a building to the elevation of the ground to calculate the total height of a corresponding point. In addition, when the point is located on the ground or the water surface, it is possible to calculate the elevation of the ground or the water surface as the total height of a corresponding point.

According to the present embodiment, the calculating of the ground surface height may include calculating the minimum value or maximum frequency of the elevations of a plurality of points as the ground surface height. According to an embodiment, the calculating of the ground surface height may calculate a frequency distribution for the elevations of a plurality of points, and calculate, as the ground surface height, the rank value of a rank having the maximum frequency on the frequency distribution, the mean value of an elevation belonging to a rank having the maximum frequency on the frequency distribution, the rank value of a rank having the minimum frequency on the frequency distribution, or the mean value of an elevation belonging to a rank having the minimum frequency on the frequency distribution.

According to another embodiment of the present invention, the collecting of the height information on the point in step S210 may further include collecting location information on a plurality of points in the region 20.

In addition, the calculating of the ground surface height may include calculating a regression equation by using regression analysis based on the location information and the elevation information, and applying location information on a point to the regression equation to calculate a ground surface height for each point.

In this example, the location information x and y may be set as an independent variable for a regression equation and the elevation information z may be set as a dependent variable.

According to an embodiment of the present invention, the calculating of the regression equation may include calculating the regression equation based on location information and elevation information on some of the points.

For example, the calculating of the regression equation may include calculating a frequency distribution for the elevations of the points, selecting a point having an elevation belonging to a rank having the maximum frequency or the minimum frequency from the frequency distribution, and calculating a regression equation based on location information and elevation information on the selected point.

The ground surface roughness calculating method 200 according to the embodiment of the present invention as described above may be manufactured as a program to be executed on a computer and may be stored in a computer readable recording medium. The computer readable recording medium includes all kinds of storage devices that store data capable of being read by a computer system. Examples of the computer readable recording medium may be a ROM, a RAM, a CD-ROM, a magnetic tape, a floppy disk, and an optical data storage device.

The above description relates to an apparatus and method for calculating ground surface roughness that collects height information on a plurality of points from a region considered when calculating wind load, and calculates the ground surface roughness of the region based on the representative value of the region obtained by using statistical data on the collected height information.

According to the apparatus and method for calculating ground surface roughness, it is possible to prevent the ground surface roughness of a region from becoming inappropriately determined by the subjective judgment of a designer and objectively and reliably calculate the ground surface roughness. By using the ground surface roughness calculated as above, it is possible to obtain an effect that may enhance the safety and economic value of a structure. Also, it is possible to prevent wind load from becoming calculated as an excessively great or small value.

What is claimed is:

1. An apparatus for calculating ground surface roughness, the apparatus comprising:
an information collecting unit collecting height information on a plurality of points in a region;
a representative value calculating unit calculating a representative value of the region by using statistical data on the height information; and
a ground surface roughness calculating unit calculating the ground surface roughness of the region according to the representative value.

2. The apparatus of claim 1, wherein the information collecting unit is configured to:
calculate the height of a building as height information on a point when the point is located on the building; and
calculate the height information on the point as 0 when the point is located on the ground or the water surface.

3. The apparatus of claim 1, wherein the points are uniformly distributed in the region.

4. The apparatus of claim 1, wherein the points 1:1 correspond to buildings in the region.

5. The apparatus of claim 1, wherein the representative value calculating unit calculates one of the median, maximum value, maximum frequency and mean value of the heights of the points and determines the calculated value as the representative value.

6. The apparatus of claim 1, wherein the representative value calculating unit calculates a frequency distribution for the heights of the points and determines the rank value of a rank having the maximum frequency on the frequency distribution as the representative value.

7. The apparatus of claim 1, wherein the information collecting unit comprises:
a sample information collecting unit collecting height information on a plurality of sample points in the region; and
a target point information obtaining unit obtaining height information on a plurality of target points in the region by using the height information on the sample points.

8. The apparatus of claim 7, wherein the target point information obtaining unit is configured to create a digital elevation model (DEM) by using height information collected on the sample points, create a plurality of target points corresponding to the grid of the DEM, and calculate the height of the grid of the DEM as height information on a target information corresponding to the grid.

9. The apparatus of claim 7, wherein the target point information obtaining unit is configured to:
create a plurality of target points in the region; and
calculate height information on the target point by using interpolation based on the height information collected on the sample point.

10. The apparatus of claim 1, wherein the information collecting unit collects information on the height and area of a building in the region, and
the representative value calculating unit applies the area of the building as weight to the height of the building to calculate a weighted average height.

11. The apparatus of claim 1, wherein the information collecting unit collects elevation information on a plurality of points in the region and total-height information that the height of a building is reflected to an elevation,
the apparatus for calculating the ground surface roughness further comprises a ground surface height calculating unit that calculates the ground surface height of the region based on the elevation information, and
the representative value calculating unit calculates the representative value of the region by using statistical data on the difference value of a total height calculated for each point and the ground surface height.

12. The apparatus of claim 11, wherein the information collecting unit is configured to:
add the height of a building to the elevation of the ground to calculate the total height of a corresponding point when the point is located on a building; and
calculate the elevation of the ground or the water surface as the total height of a corresponding point when the point is located on the ground or the water surface.

13. The apparatus of claim 11, wherein the ground surface height calculating unit calculates the minimum value or maximum frequency of the elevations of the points as the ground surface height.

14. The apparatus of claim 11, wherein the ground surface height calculating unit is configured to: calculate a frequency distribution for the elevations of the points; and
calculate, as the ground surface height, the rank value of a rank having the maximum frequency on the frequency distribution, the mean value of an elevations belonging to a rank having the maximum frequency on the frequency distribution, the rank value of a rank having the minimum frequency on the frequency distribution, or the mean value of elevations belonging to a rank having the minimum frequency on the frequency distribution.

15. The apparatus of claim 11, wherein the information collecting unit further collects location information on a plurality of points in the region, and
the ground surface height calculating unit uses regression analysis to calculate a regression equation based on the location information and the elevation information and applies the location information to the regression equation to calculate a ground surface height for each point.

16. The apparatus of claim 15, wherein the ground surface height calculating unit sets the location information as an independent variable and the elevation information as a dependent variable to calculate the regression equation.

17. The apparatus of claim 15, wherein the ground surface height calculating unit calculates the regression equation based on location information and elevation information on some of the points.

18. The apparatus of claim 17, wherein the ground surface height calculating unit is configured to:
calculate a frequency distribution for the elevations of the points;
select a point having an elevation belonging to a rank having the maximum or minimum frequency on the frequency distribution; and
calculate the regression equation based on location information and elevation information on the selected point.

19. A method of calculating ground surface roughness in a region by using a ground surface roughness calculating apparatus including an information collecting unit, a representative value calculating unit, and a ground surface roughness calculating unit, the method comprising:
collecting, by the information collecting unit, height information on a plurality of points in a region;
calculating, by the representative value calculating unit, a representative value of the region by using statistical data on the height information; and
calculating, by the ground surface roughness calculating unit, the ground surface roughness of the region according to the representative value.

20. A computer readable recording medium on which a program to be executed on a computer is recorded, wherein the program implements a method of calculating ground surface roughness that comprises:
collecting, by an information collecting unit, height information on a plurality of points in a region;
calculating, by a representative value calculating unit, a representative value of the region by using statistical data on the height information; and
calculating, by a ground surface roughness calculating unit, the ground surface roughness of the region according to the representative value.
